(19) United States
(12) Patent Application Publication
(10) Pub. No.: US 2010/0023555 A1
(43) Pub. Date: Jan. 28, 2010

(54) SYSTEM AND METHOD FOR ASSOCIATING A FILE WITH ONE OR MORE OTHER FILES IN AN ONLINE STORAGE SYSTEM

(76) Inventor: Don MACASKILL, Los Altos, CA (US)

Correspondence Address: PATTERSON & SHERIDAN, L.L.P., 3040 POST OAK BOULEVARD, SUITE 1500, HOUSTON, TX, 77056, US

(21) Appl. No.: 12/488,477

(22) Filed: Jun. 19, 2009

Related U.S. Application Data
(60) Provisional application No. 61/081,354, filed on Jul. 16, 2008.

(51) Int. Cl. G06F 17/30

(52) U.S. Cl. 707/104.1; 707/E17.019; 715/764

(57) ABSTRACT

A method for associating images stored a memory associated with an online server. The method includes receiving a first file having a first file format and a second file having a second file format, where the first file is associated with a file size that is smaller than a file size associated with the second file. The method further includes associating the first file with the second file, where an image associated with the first file and the second file, when selected by a user, allows the user to access each of the first file and the second file. Advantageously, since one file can be associated with (or “entangled with”) another file, a user of an online storage system can more easily organize and locate related files.

### CROSS-REFERENCE TO RELATED APPLICATIONS

This application claims priority to U.S. Provisional Patent Application No. 61/081,354, filed Jul. 16, 2008, and entitled “AUTOMATIC BUNDLING AND VISUAL BROWSING OF FILES FOR DISPLAYED IMAGES AND VIDEOS,” which is hereby incorporated herein by reference.

### BACKGROUND

1. Field of the Invention

The present invention relates to the field of computer software and, in particular, to a system and method for associating a file with one or more other files in an online storage system.

2. Description of the Related Art

Photography is a popular activity for both professionals and amateurs alike. Digital photography, especially, is an activity that has enjoyed widespread growth in recent years based on the proliferation of digital camera technology. As the art of digital photography becomes more widely adopted, the management of digital media files has become more sophisticated. Many types of media files are currently available, including digital images and digital videos. Additionally, for each media type, various formats are available. For example, digital single-lens reflex cameras (digital SLRs or DSLRs) often allow users to capture digital images in the RAW file format as well as in other file formats, such as in the Joint Photographic Experts image file format (JPEG or JPG). Numerous other formats exist as well.

The RAW file format includes data that has been delivered, unprocessed, and/or minimally processed, from the digital sensor included in the digital camera. Images having the RAW file format are sometimes referred to as “digital negatives,” since the RAW file format achieves the same goal as film negatives, i.e., allows the user to generate a final version of the image from the RAW file format. As is known, a user may utilize image processing software to process images having the RAW file format to enhance the visual quality of the image.

In addition to the RAW file format, many digital cameras support the JPEG file format. An image having the JPEG file format, also simply referred to as “a JPEG,” is a compressed image file that offers a reduced file size in exchange for a reduced image quality. With typical JPEG images, a small decrease in image quality is associated with a large decrease in file size.

The JPEG file format and the RAW file format offer different features to users desiring to store their digital images online. Typically, RAW image files have a relatively large file size and are not supported by various online photo sharing systems. However, even when an online storage system does support the capability of storing RAW image files, many web browser application do not support displaying RAW image files. Typically, images having other file formats, e.g., JPEG, have a smaller file size and tend to be supported for display. However, as described above, JPEG images suffer from lower quality.

One problem with conventional file storage systems is that they do not provide users with a convenient way to store files of various file formats. In one conventional approach, only files having one of a specific list of file types may be stored on an online server, thereby limiting the usefulness of the online storage system. In other conventional approaches, files of any file type may be stored on the online server. The files are typically organized in a hierarchical folder directory similar to a desktop computer folder directory. However, locating specific files within the folder directory may be inconvenient for the user, especially when the number of folders is large, the number of files stored in large, and/or the user does not remember where the file is stored.

As the foregoing illustrates, there is a need in the art for an improved technique for storing images in an online storage system.

### SUMMARY

One embodiment of the invention provides a method for associating images stored a memory associated with an online server. The method includes receiving a first file having a first file format and a second file having a second file format, where the first file is associated with a file size that is smaller than a file size associated with the second file. The method further includes associating the first file with the second file, where an image associated with the first file and the second file, when selected by a user, allows the user to access each of the first file and the second file.

Advantageously, since one file can be associated with (or “entangled with”) another file, a user of an online storage system can more easily organize and locate related files.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a system configured to implement one or more aspects of the present invention.

FIG. 2 is a block diagram illustrating an image entangling storage manager (IESM), according to one embodiment of the invention.

FIG. 3 is a flow diagram of method steps for manually associating a first file with a second file, according to one embodiment of the invention.

FIG. 4 is a flow diagram of method steps for automatically associating a first file with a second file, according to one embodiment of the invention.

FIG. 5 is a flow diagram of method steps for causing a user interface to be displayed that allows a user to identify associated files, according to one embodiment of the invention.

FIGS. 6A-6D are screenshots of examples of a user interface for allowing the user to access one or more other files that are associated with a primary file included in a gallery, according various embodiments of the invention.

FIG. 7 is a flow diagram of method steps for causing a user interface associated with a gallery to be displayed to a first user who is not the owner of the gallery, according to one embodiment of the invention.

FIG. 8 is a screenshot of an example of a user interface of a gallery shared by a first user to a second user, according to one embodiment of the invention.

FIG. 9 is a flow diagram of method steps for generating an image file based on receiving a first file, according to one embodiment of the invention.

FIG. 10 is a block diagram of a computer system comprising one or more of the user devices and/or server devices described herein, according to one embodiment of the invention.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

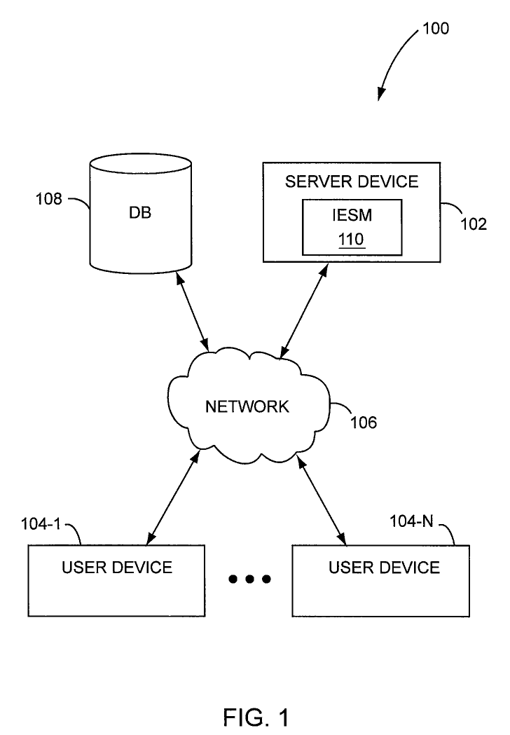

FIG. 1 is a block diagram of a system 100 configured to implement one or more aspects of the present invention. As shown, the system 100 includes a server device 102, user devices 104-1 through 104-N, a network 106, and a memory 108. The server device 102 includes an image entangling storage manager (IESM) 110.

The server device 102 may be any technically feasible type of computing device, including a laptop computer, a desktop computer, a server computer, a computer workstation, a hand-held computing device, personal digital assistant (PDA), or a cell phone, among others things.

User devices 104-1 through 104-N may also be any technically feasible type of computing device, including a laptop computer, a desktop computer, a server computer, a computer workstation, a hand-held computing device, personal digital assistant (PDA), or a cell phone, among others things.

The network 106 may be any type of network, including the World Wide Web, the Internet, a local area network (LAN), a wide area network (WAN), an intranet, a cellular network, or any other technically feasible type of network. The user devices 104-1 through 104-N can communicate with one another and with the server device 102 via the network 106.

In one embodiment, the IESM 110 is a software application executed by a processor included within the server device 110. In alternative embodiments, the IESM 110 may be fixed function hardware.

In one embodiment, the server device 102 is a web server, and the IESM 110 is included as part of the web server that hosts a website for users to store files in one or more galleries and to share the one or more galleries with other. The memory 108 may be a server, a database, a random access memory (RAM), a CD-ROM, a DVD-ROM, or any other type of technically feasible memory and/or storage unit. The files stored in the one or more galleries are stored in the memory 108. In one embodiment, the memory 108 is coupled to the server device 102 and is not included within the server device 102 (as shown in FIG. 1). For example, the memory may be hosted by a third party online storage web service, such as Amazon Simple Storage Service (Amazon S3) provided by Amazon.com, Inc. In alternative embodiments, the memory 108 may be included within the server device 102. In some embodiments, the memory 108 may be a distributed memory structure comprising multiple memory devices and/or memory clusters.

In the example of FIG. 1, in operation, the first user device 104-1 causes one or more files to be transmitted to the server device 102 for storage in the memory 108. The first user may have previously registered a user account with a gallery hosting website associated with the server device 102. The one or more files may have any one of a number of different file types. For example, the one or more files may have an image file format, a spreadsheet file format, or any other file format. Examples of file formats include a JPEG (joint photographic experts group) file format, a GIF (graphics interchange format) file format, PNG (portable network graphics) file format, a RAW file format, a TIFF (tagged image file format) file format, and numerous other file formats.

In one embodiment, the IESM 110 is configured to associate (or “entangle”) two different files stored in the memory. The two files may include a first file having a small file size and low image quality, and a second file having larger and high quality image. For example, the first file may be a JPEG file, and the second file may be a RAW file. In one embodiment, the IESM 110 receives first and second files and entangles the files together, associating the first and second files with an image common to both files. Data representing the association may be also stored in the memory 108. The first and second files may be associated with a “gallery” that is associated with an account of the first user. The first user may then “share” the gallery with one or more other users. When a gallery is shared with a second user, the second user is able to access, view, and/or download one or more of the files associated with the gallery. Persons skilled in the art would understand that sharing a gallery with other users can be implemented using a wide variety of techniques.

In one embodiment, the gallery that includes the first and second files is shared with a second user. The second user may be using and/or manipulating user device 104-N. The second user may cause a request to be transmitted from the user device 104-N to the server machine 102 to access the gallery. For example, the IESM 110 may receive a request from the user device 104-N to display the first file having the smaller size to the second user via a display device associated with the user device 104-N. In response, the IESM 110 may transmit the first file to the user device 104-N for display. The user device 104-N may also request other files. For example, if the gallery includes more than one file, then the request may be a request to display any number of files.

In still further embodiments, the first user, who caused the first and second files to be stored in the memory 108, may request to access the first and second files. In one embodiment, the IESM 110 causes a thumbnail of the first file to be displayed to the first user along with an indication that one or more other files are associated with the first file, e.g., the second file. When the indication is selected (e.g., by clicking on an icon with a mouse pointer), the first user is provided access to the one or more other files associated with the first file. The first user may then view, access, and/or download the one or more other files to the user device 104-1.

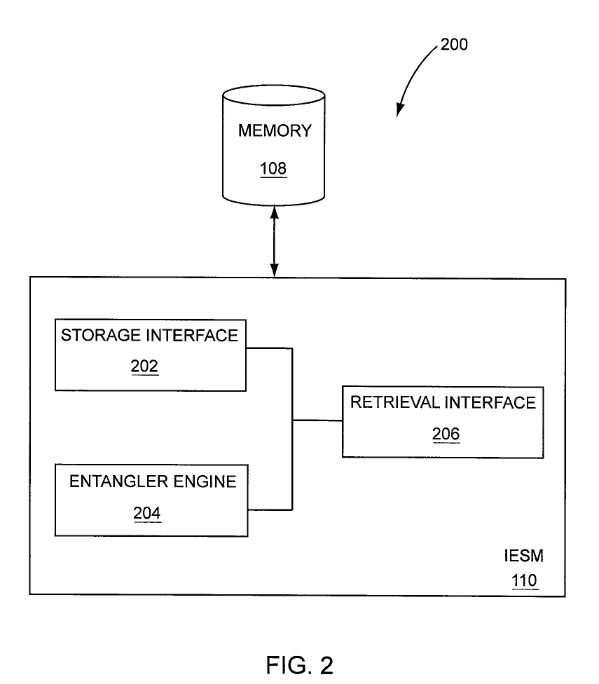

FIG. 2 is a block diagram illustrating an image entangling storage manager (IESM) 110, according to one embodiment of the invention. As shown, the IESM 110 includes a storage interface 202, an entangler engine 204, and a retrieval interface 206. Also as shown, the IESM 110 may be coupled to a memory 108.

The storage interface 202 is configured to receive one or more files from a user device and to provide the one or more files to the entangler engine 208 for processing, and/or to provide the one or more files for storage in the memory 108. In some embodiments, the storage interface 202 is configured to generate a user interface that is transmitted via the network 106 to the user device. A user may interact with the user interface to cause the one or more files to be stored in the memory 108.

The entangler engine 208 is configured to parse one or more image files and to perform various processing operations, as described in greater detail herein. The one or more files received from the user device and/or processed by the entangler engine 208 are stored in the memory 108.

The retrieval interface 206 is configured to retrieve one or more files from the memory 108 and to generate a user interface for allowing a user to access the one or more files via a user device.

In some embodiments, the storage interface 202, the entangler engine 204, and/or the retrieval interface 206 may implemented as software modules, webpages, or other units operating within the server device 102.

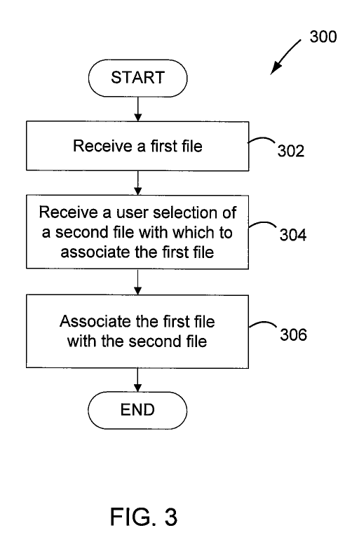

FIG. 3 is a flow diagram of method steps for manually associating a first file with a second file, according to one embodiment of the invention. Persons skilled in the art will understand that, even though the method 300 is described in conjunction with the systems of FIGS. 1-2, any system configured to perform the method steps, in any order, is within the scope of embodiments of the invention.

As shown, the method 300 begins at step 302, where the IESM receives a first file. The first file may have been uploaded to the IESM via a network from a user device operated by the first user. In one embodiment, the first user has previously registered with an online storage service hosted by a web server associated with the IESM. In one embodiment, the first file is received by the storage interface 202, as discussed in reference to FIG. 2.

The first file may have a first file type. For example, the first file type may be a lower-quality image file type, such as a JPEG file type. In some embodiments, the first file may have a relatively small size to facilitate rapid transmission over the network 106.

In some embodiments, the first file received at step 302 is received as part of a request to add the first file to a particular “gallery” associated with an account of the first user. As described herein, the account associated with the first user may include one or more galleries of files. Each gallery can be separately shared with one or more other users. As persons having ordinary skill in the art would understand, various other alternatives for sharing galleries with other users are within the scope of embodiments of the invention.

At step 304, the IESM receives a user selection of a second file with which to associate the first file. As described above, in some embodiments, the first file received at step 302 is received as part of a request to add the first file to a particular gallery associated with the account of the first user. In embodiments, the second file is stored in the particular gallery associated with the request to add the first file.

At step 306, the IESM associates the first file with the second file. In one embodiment, the first file and the second file are “entangled” with one another. The entangler 208, as discussed in reference to FIG. 2, may perform entanglement of the first and second files by associating them with a common image shared by the files. Additionally, in some embodiments, database records may be created associating the first and second files, file names could be changed to relate the files, and/or any technically feasible technique for associating two files may be used. Again, in some embodiments, one or more of the first and second files are not image files, and may be spreadsheet files, text files, or any other type of file.

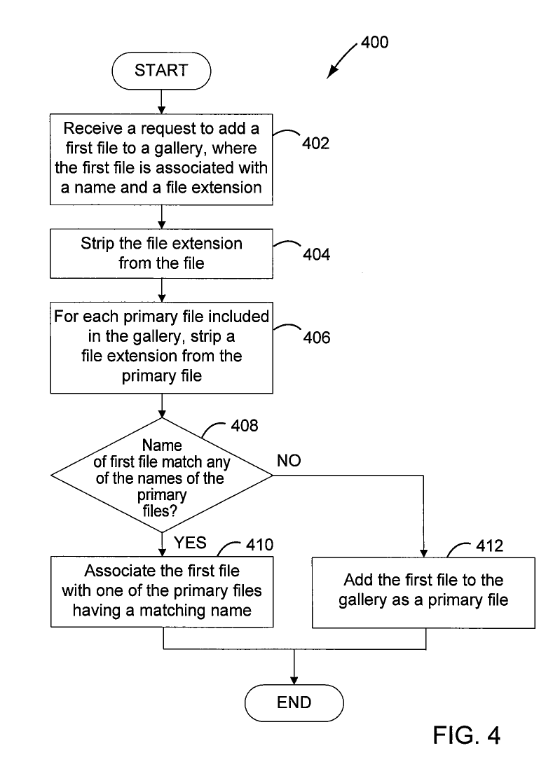

FIG. 4 is a flow diagram of method steps for automatically associating a first file with a second file, according to one embodiment of the invention. Persons skilled in the art will understand that, even though the method 400 is described in conjunction with the systems of FIGS. 1-2, any system configured to perform the method steps, in any order, is within the scope of embodiments of the invention.

As shown, the method 400 begins at step 402, where the IESM receives a request to add a first file to a gallery, where the first file is associated with a name and a file extension. As is known, files include a name portion and a file extension portion. For example, the file PHOTO.JPG includes a name PHOTO and a file extension JPG.

At step 404, the IESM strips the file extension from the first file. At step 406, for each primary file included in the gallery, the IESM strips a file extension from the primary file. In one embodiment, a gallery may include primary files and secondary files. Primary files are the top-level files included in the gallery. When an other file is entangled with a primary file, the other file becomes a secondary file associated with the primary file.

At step 406, the IESM determines whether the name of the first file matches the name of any of the primary files included in the gallery. If the IESM determines that the name of the first file matches the name of at least one primary files included in the gallery, then the method proceeds to step 410.

At step 410, the IESM associates the first file with one of the primary files having a matching name. As described above, the first file is entangled with the primary file. In some embodiments, where more than one primary file has the same name as the first file, the first file may be entangled with each of the primary files having the same name. In still further embodiments, where more than one primary file has the same name as the first file, the first file may be entangled with a particular primary file based on a specific user selection.

Referring again to step 406, if the IESM determines that the name of the first file does not match the name of any of the primary files included in the gallery, then the method proceeds to step 412. At step 412, the IESM adds the first file to the gallery as a separate primary file.

In some embodiments, even when the first file has the same name as a primary file included in the gallery, the first file is stored as a separate primary file. For example, in some embodiments, if the first file has the same name and the same file extension as a primary file included in the gallery, then the first file is added to the gallery as a separate primary file.

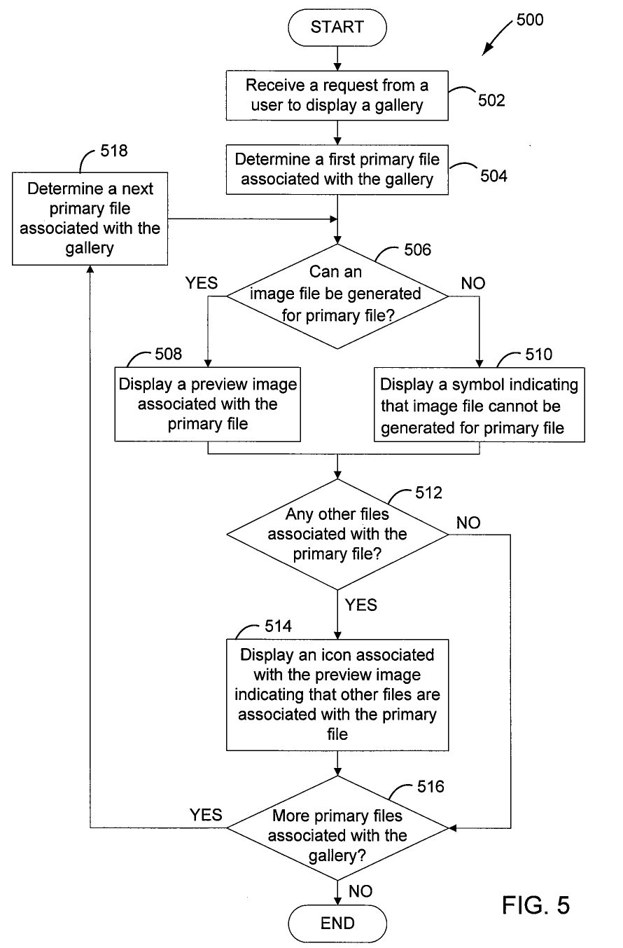

FIG. 5 is a flow diagram of method steps for causing a user interface to be displayed that allows a user to identify associated files, according to one embodiment of the invention. Persons skilled in the art will understand that, even though the method 500 is described in conjunction with the systems of FIGS. 1-2, any system configured to perform the method steps, in any order, is within the scope of embodiments of the invention.

As shown, the method 500 begins at step 502, where the IESM receives a request from a user to display a gallery. In one embodiment, the user has previously registered an account and is the user that created the requested gallery.

At step 504, the IESM determines a first primary file associated with the gallery. As described above, in one embodiment, the gallery may include primary files and secondary files. Primary files are the top-level files included in the gallery. Other files that are entangled with a primary file are referred to as a secondary files associated with the primary file.

At step 506, the IESM determines whether an image file can be generated for the primary file. If yes, then the method 500 proceeds to step 508. At step 508, the IESM causes a preview image associated with the primary file to be displayed to the user. In one embodiment, the preview image is a thumbnail image of the primary file.

If, at step 506, the IESM determines that an image file cannot be generated for the primary file, then the method 500 proceeds to step 510. At step 510, the IESM causes a symbol to be displayed to the user indicating that an image file cannot be generated for the primary file. In one embodiment, the symbol represents a file archive.

From each of steps 508 and 510, the method 500 proceeds to step 512. At step 512, the IESM determines whether any other files are associated with the primary file. If the IESM determines that at least one other file is associated with the primary file, then the method 500 proceeds to step 514.

At step 514, the IESM causes an icon associated with the preview image to be displayed to the user indicating that at least one other file is associated with the primary file. In one embodiment, the icon is a graphical notation displayed over a portion of the display image. In alternative embodiments, the icon is textual. In still further embodiments, the icon is displayed adjacent to the preview image.

If, at step 512, the IESM determines that there are no other files associated with the primary file, then the method 500 proceeds to step 516. At step 516, the IESM determines whether any more primary files are associated with the gallery.

If, at step 516, the IESM determines that at least one more primary file is associated with the gallery, then the method 500 proceeds to step 518, where the IESM determines a next primary file associated with the gallery. The method 500 then proceeds to step 506, described above.

Referring again to step 516, if the IESM determines that no more primary files are associated with the gallery, then the method 500 terminates.

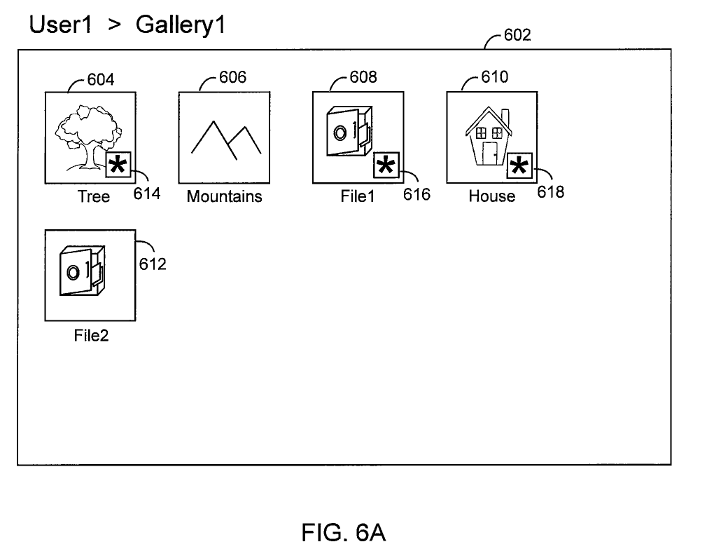

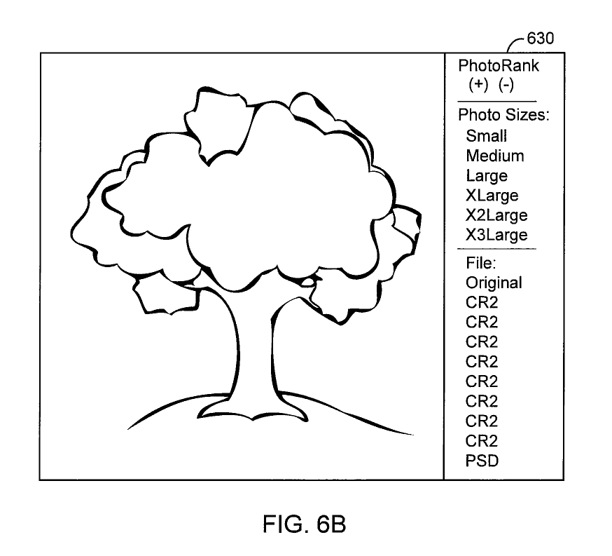

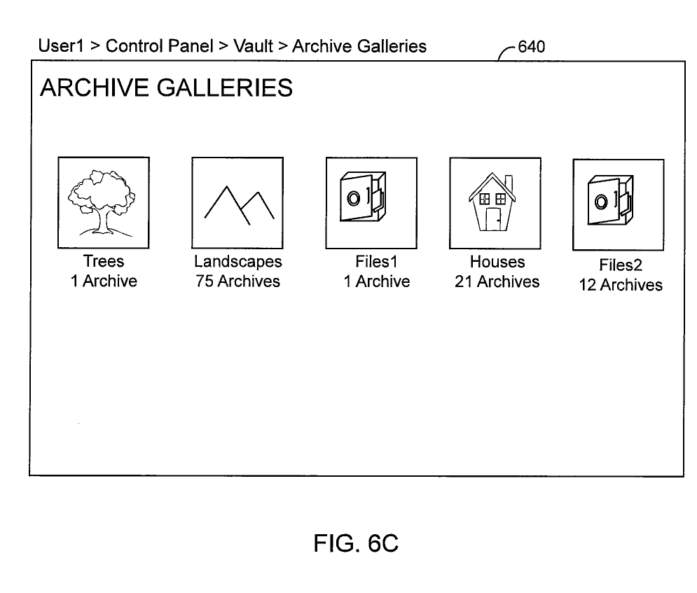

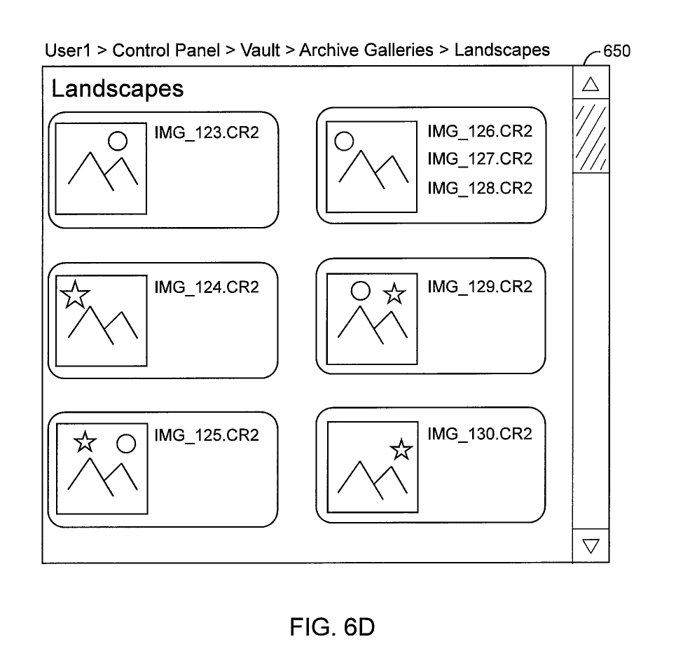

FIGS. 6A-6D are screenshots of examples of a user interface for allowing the user to access one or more other files that are associated with a primary file included in a gallery, according various embodiments of the invention.

FIG. 6A is one embodiment of a screenshot of a gallery 602. As shown, the gallery 602 is labeled “Gallery1.” In one embodiment, the gallery 602 was created by a first user, e.g., “User1.” The screenshot shown in FIG. 6A represents one embodiment of what is displayed to the first user when the first user accesses the gallery.

In the example shown in FIG. 6A, the gallery 602 includes five primary files, including files 604, 606, 608, 610, and 612. The files 604, 606, 610 represent image files; whereas, the files 608 and 612 represent non-image files. As shown, a preview image is displayed for each of the files 604, 606, 610 representing image files, and a symbol is display for each of files 608 and 612 representing non-image files.

Additionally, as also shown in FIG. 6A, icon 614 is associated with file 604, icon 616 is associated with file 608, and icon 618 is associated with file 610. As described herein, an icon 614, 616, 618 is displayed with a file when one or more other files are associated with, or “entangled with,” the file. Accordingly, displaying the icons 614, 616, 618 with the files 604, 608, 610, respectively, indicates that each of files 604, 608, 610 is entangled with at least one other file. In contrast, files 606 and 612 are not depicted with an icon. Accordingly, no other files are entangled with files 606 and 612.

In some embodiments, as shown in FIG. 6A, an icon indicating that one or more other files is associated with a particular file may be displayed with both image files and non-image files. For example, files 604 and 610 are image files; whereas, file 608 is a non-image file.

FIG. 6B is a screenshot illustrating a user interface for allowing the user to access one or more other files that are associated with a primary file included in a gallery, according to one embodiment of the invention. For example, when a user selects one of the files shown in FIG. 6A that is indicated as being entangled with other files (e.g., the user selects file 604, 608, or 610), then an interface 630, as shown in FIG. 6B, may be displayed. The interface 630 shows the primary image in a substantially full-screen view. Additionally, a sidebar is displayed with the interface 630 that provides options to the user. For example, the user may view the image in one or more different photo sizes. Additionally, each of the other files associated with the primary file may be accessed via the sidebar. As shown, the primary file is associated with eight different CR2 files and one PSD file.

FIG. 6C is a screenshot illustrating a user interface for allowing the user to access one or more other files that are associated with a primary file included in a gallery, according to one embodiment of the invention. Rather than retrieving entangled through a gallery interface, the IESM may be configured to provide a consolidated interface 640 that includes only the galleries that include at least one file that is associated with entangled files. For example, a user's account may include twenty-five galleries, but only five galleries include files that are entangled with other files. By accessing the consolidated interface 640, the user may be able to quickly ascertain which five galleries include entangled files. The consolidated interface 640 may provide additional information to the user, such as, for example, for each gallery in the consolidated interface 640, a total number of other files (e.g., “archives”) that are entangled with primary files and/or a total number of primary files that are entangled with other files.

FIG. 6D is a screenshot illustrating a user interface for allowing the user to access one or more other files that are associated with a primary file included in a gallery, according to one embodiment of the invention. In one embodiment, when the user selects one of the galleries included in the consolidated interface 640, as described in FIG. 6C, the user may be presented with a gallery consolidated interface 650, as shown in FIG. 6D. For example, the user has selected the “Landscapes” gallery from the consolidated interface 640, where the Landscapes gallery includes seventy-five files that are entangled with primary files. After selecting the Landscapes gallery, the user is presented with the gallery consolidated interface 650, shown in FIG. 6D. A thumbnail of each primary file is displayed in the gallery consolidated interface 650, along with links for the user to download one or more of the other files entangled with each of the primary files.

In some embodiments, the retrieval interface 206 described in FIG. 2 is configured to generate one or more of the interfaces shown in FIGS. 6A-6D.

As described above, each of the screenshots shown in FIGS. 6A-6D represents one or more user interfaces that are displayed to a user who is the particular user that created the gallery that includes entangled files.

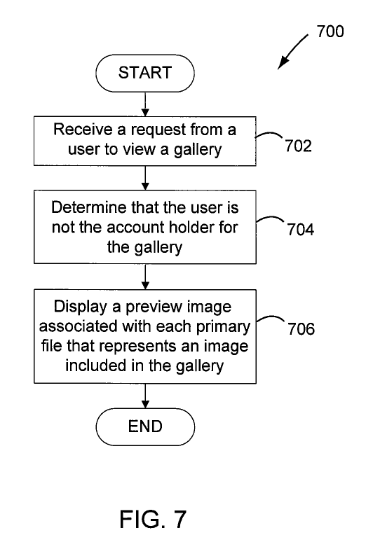

FIG. 7 is a flow diagram of method steps for causing a user interface associated with a gallery to be displayed to a first user who is not the owner of the gallery, according to one embodiment of the invention. Persons skilled in the art will understand that, even though the method 700 is described in conjunction with the systems of FIGS. 1-2 and 6A-6D, any system configured to perform the method steps, in any order, is within the scope of embodiments of the invention.

As shown, the method 700 begins at step 702, where the IESM receives a request from the first user to view the gallery. As described, the first user is not the owner of the gallery. For example, the gallery may have been created by a second user who shared the gallery with the first user.

At step 704, the IESM determines that the first user is not the owner of the gallery. At step 706, the IESM causes a preview image associated with each primary file included in the gallery that represents an image to be displayed to the user. Accordingly, in some embodiments, any primary files included in the gallery that represent non-image files are not displayed to the user. Additionally, in some embodiments, no symbol is displayed indicating that one of the primary files is not an image file. In still further embodiments, no icon is displayed along with the primary files indicating that the primary file is entangled with other files.

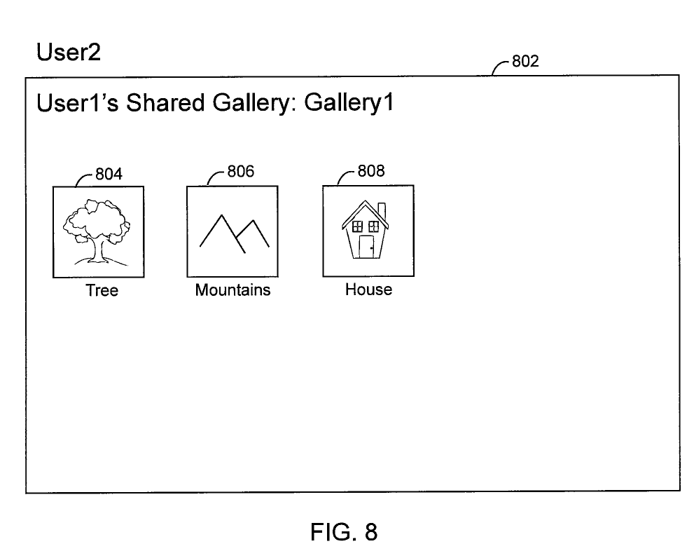

FIG. 8 is a screenshot of an example of a user interface of a gallery shared by a first user to a second user, according to one embodiment of the invention. As shown, the gallery 802 includes files 804, 806, and 808. In one embodiment, the gallery shown in FIG. 8 is the same gallery, “Gallery1,” shown in FIG. 6A. However, in FIG. 8, a second user, e.g., User2, is viewing the gallery, which is owned by a first user, e.g., User1. According to the steps of the method 700, the symbols associated with files 608 and 612 are not displayed in the gallery 802. Additionally, no icons are shown in the gallery 802 indicating that any of the files 804, 806, 808 is entangled with one or more other files.

In alternative embodiments, the first user may be presented with a toggle that allows other users with which a gallery is shared, e.g., the second user, to be able to view the same gallery 602 that is displayed to the first user. Accordingly, the second user would have access the non-image primary files and/or to the other files entangled with the primary files.

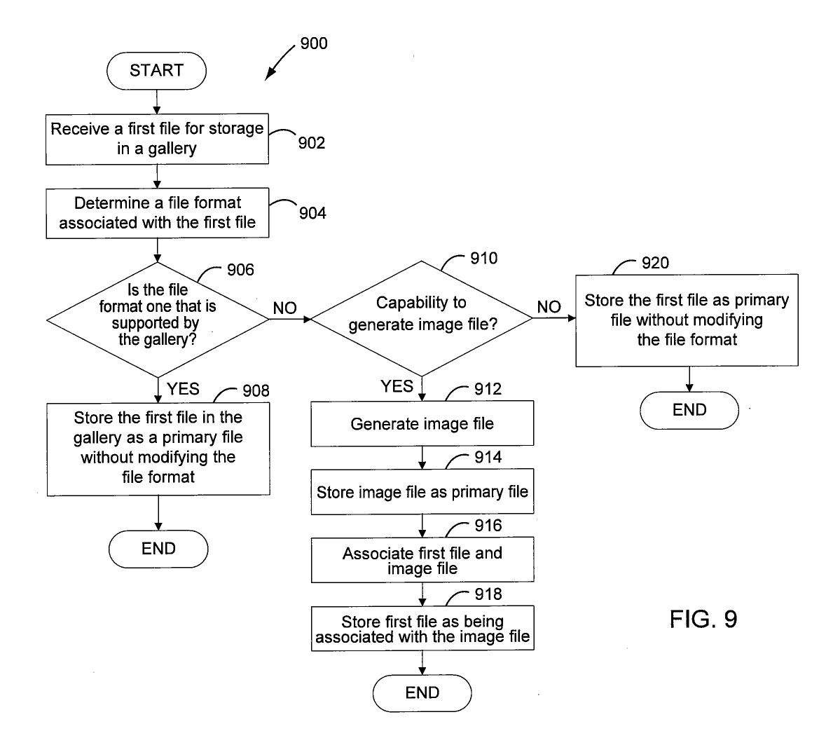

FIG. 9 is a flow diagram of method steps for generating an image file based on receiving a first file, according to one embodiment of the invention. Persons skilled in the art will understand that, even though the method 900 is described in conjunction with the systems of FIGS. 1-2, 6A-6D, and 8, any system configured to perform the method steps, in any order, is within the scope of embodiments of the invention.

As shown, the method 900 begins at step 902, where the IESM receives a first file for storage in a gallery. At step 904, the IESM determines a file format associated with the first file. In one embodiment, certain file formats are more suitable for display on a display device. For example, the JPG file format, the portable network graphic (PNG) file format, and the graphics interchange format (GIF) file format are commonly used to display images over the Internet. Other file types, such RAW file types, do not display well on a display device. A digital camera manufactured by a particular manufacturer may be configured to generate RAW image files having a proprietary image format. Examples include: 0.3fr (Hasselblad); .arw .srf .sr2 (Sony); .bay (Casio); .crw .cr2 (Canon); cap .tif .iiq .eip (Phase_One); .dcs .dcr .drf .k25.kdc .tif (Kodak); .dng (Adobe); .erf (Epson); ifff (Imacon); mef (Mamiya); mos (Leaf); .mrw (Minolta); nef .nrw (Nikon); .orf (Olympus); .ptx .pef (Pentax); .pxn (Logitech); .r3d (Red); raf (Fuji); raw .rw2 (Panasonic); .raw .dng (Leica); .rwz (Rawzor); .x3f (Sigma).

At step 906, the IESM determines whether the file format associated with the first file is included in a list of file formats that are supported by the gallery. In one embodiment, the list of file formats includes the JPG file format, the PNG file format, and the GIF file format. If the IESM determines that the file format associated with the first file is included in the list of file formats, then the method 900 proceeds to step 908, where the first file is added to the gallery as a primary file without modifying the file format of the first file. In one embodiment, the online storage server may provide unlimited storage for files having a supported file type as part of the subscription package for the online storage server. Storage of files having unsupported file formats, in some embodiments, may require the user to pay a fee to a third party service provider.

If, at step 906, the IESM determines that the file format associated with the first file is not included in the list of file formats, then the method 900 proceeds to step 910. At step 910, the IESM determines whether the IESM includes the functionality to generate an image file for files having the file format associated with the first file. If, at step 910, the IESM determines that the IESM does not include the functionality to generate the image file for files having the file format associated with the first file, then the method proceeds to step 920. At step 920, the IESM stores the first file as a primary file without modifying the file format of the first file. In one embodiment, the first file is represented by a symbol indicating that the first file is a non-image file. For example, the file format may be an XLS file format representing a spreadsheet file, and the IESM may not include the functionality to convert an XLS file to an image file. Accordingly, the XLS file is stored in the gallery and is represented by a symbol indicating that an image file cannot be generated for the first file.

If, at step 910, the IESM determines that the IESM does include the functionality to generate the image file, then the method proceeds to step 912. At step 912, the IESM generates an image file associated with the first image. Various image processing techniques may be used to generate the image file. For example, image processing solutions provided by ImageMagick Studio LLC may convert a RAW image to a JPG image. In some embodiments, the entangler engine 204, described in FIG. 2, performs step 912.

At step 914, the IESM stores the image file as a primary file in the gallery. At step 916, the IESM associates (or “entangles”) the first file with the image file. At step 918, the IESM stores the first file in the gallery as a secondary file that is entangled with the image file.

In some alternative embodiments, one or more of the techniques described in FIGS. 3-9 may be implemented in conjunction one or more of the other techniques described in FIGS. 3-9.

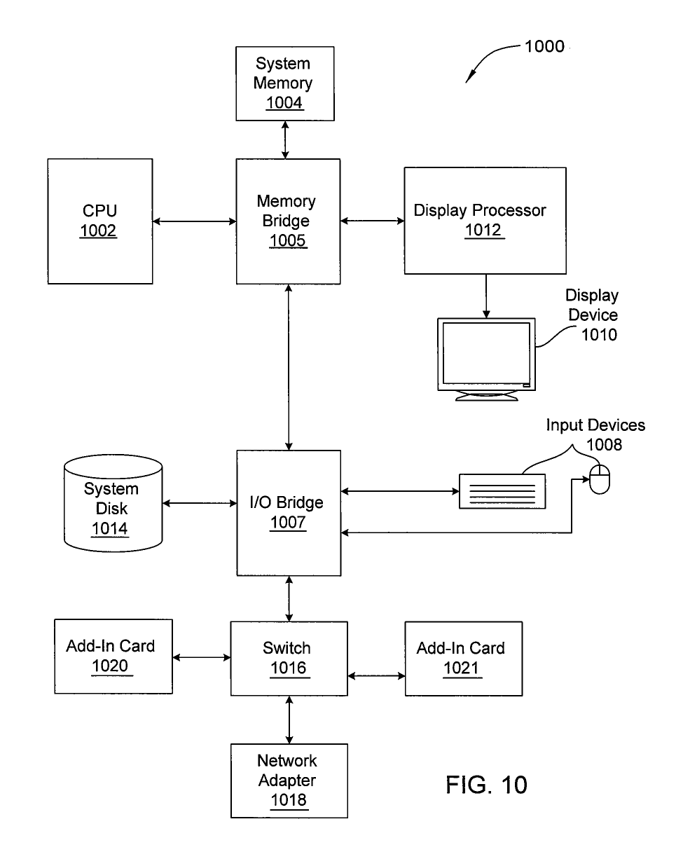

FIG. 10 is a block diagram of a system 1000 comprising one or more of the user devices and/or server devices described herein, according to one embodiment of the invention. System 1000 may be a computer workstation, personal computer, video game console, personal digital assistant, rendering engine, or any other device suitable for practicing one or more embodiments of the present invention.

As shown, system 1000 includes a central processing unit (CPU) 1002 and a system memory 1004 communicating via a bus path that may include a memory bridge 1005. CPU 1002 includes one or more processing cores, and, in operation, CPU 1002 is the master processor of system 1000, controlling and coordinating operations of other system components. System memory 1004 stores software applications and data for use by CPU 1002. CPU 1002 runs software applications and optionally an operating system. Memory bridge 1005, which may be, e.g., a Northbridge chip, is connected via a bus or other communication path (e.g., a HyperTransport link) to an I/O (input/output) bridge 1007. I/O bridge 1007, which may be, e.g., a Southbridge chip, receives user input from one or more user input devices 1008 (e.g., keyboard, mouse, joystick, digitizer tablets, touch pads, touch screens, still or video cameras, motion sensors, and/or microphones) and forwards the input to CPU 1002 via memory bridge 1005.

A display processor 1012 is coupled to memory bridge 1005 via a bus or other communication path (e.g., a PCI Express, Accelerated Graphics Port, or HyperTransport link); in one embodiment display processor 1012 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 1004.

Display processor 1012 periodically delivers pixels to a display device 1010 (e.g., a screen or conventional CRT, plasma, OLED, SED or LCD based monitor or television). Additionally, display processor 1012 may output pixels to film recorders adapted to reproduce computer generated images on photographic film. Display processor 1012 can provide display device 1010 with an analog or digital signal.

A system disk 1014 is also connected to I/O bridge 1007 and may be configured to store content and applications and data for use by CPU 1002 and display processor 1012. System disk 1014 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 1016 provides connections between I/O bridge 1007 and other components such as a network adapter 1018 and various add-in cards 1020 and 1021. Network adapter 1018 allows system 1000 to communicate with other systems via an electronic communications network, and may include wired or wireless communication over local area networks and wide area networks such as the Internet.

Other components (not shown), including USB or other port connections, film recording devices, and the like, may also be connected to I/O bridge 1007. For example, an audio processor may be used to generate analog or digital audio output from instructions and/or data provided by CPU 1002, system memory 1004, or system disk 1014. Communication paths interconnecting the various components in FIG. 10 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 1012 incorporates circuitry optimized for graphics and video processing, including, for example, video output circuitry, and constitutes a graphics processing unit (GPU). In another embodiment, display processor 1012 incorporates circuitry optimized for general purpose processing. In yet another embodiment, display processor 1012 may be integrated with one or more other system elements, such as the memory bridge 1005, CPU 1002, and I/O bridge 1007 to form a system on chip (SoC). In still further embodiments, display processor 1012 is omitted and software executed by CPU 1002 performs the functions of display processor 1012.

Pixel data can be provided to display processor 1012 directly from CPU 1002. In some embodiments of the present invention, instructions and/or data representing a scene are provided to a render farm or a set of server computers, each similar to system 1000, via network adapter 1018 or system disk 1014. The render farm generates one or more rendered images of the scene using the provided instructions and/or data. These rendered images may be stored on computer-readable media in a digital format and optionally returned to system 1000 for display. Similarly, stereo image pairs processed by display processor 1012 may be output to other systems for display, stored in system disk 1014, or stored on computer-readable media in a digital format.

Alternatively, CPU 1002 provides display processor 1012 with data and/or instructions defining the desired output images, from which display processor 1012 generates the pixel data of one or more output images, including characterizing and/or adjusting the offset between stereo image pairs. The data and/or instructions defining the desired output images can be stored in system memory 1004 or graphics memory within display processor 1012. In an embodiment, display processor 1012 includes 3D rendering capabilities for generating pixel data for output images from instructions and data defining the geometry, lighting shading, texturing, motion, and/or camera parameters for a scene. Display processor 1012 can further include one or more programmable execution units capable of executing shader programs, tone mapping programs, and the like.

It will be appreciated that the system shown herein is illustrative and that variations and modifications are possible. The connection topology, including the number and arrangement of bridges, may be modified as desired. For instance, in some embodiments, system memory 1004 is connected to CPU 1002 directly rather than through a bridge, and other devices communicate with system memory 1004 via memory bridge 1005 and CPU 1002. In other alternative topologies display processor 1012 is connected to I/O bridge 1007 or directly to CPU 1002, rather than to memory bridge 1005. In still other embodiments, I/O bridge 1007 and memory bridge 1005 might be integrated into a single chip. The particular components shown herein are optional; for instance, any number of add-in cards or peripheral devices might be supported. In some embodiments, switch 1016 is eliminated, and network adapter 1018 and add-in cards 1020, 1021 connect directly to I/O bridge 1007.

Network computers are another type of computer system that can be used in conjunction with the teachings provided herein. Network computers do not usually include a hard disk or other mass storage, and the executable programs are loaded from a network connection into the memory 1004 for execution by the CPU 1002. A Web TV system, which is known in the art, is also considered to be a computer system, but it may lack some of the features shown in FIG. 10, such as certain input or output devices. A typical computer system will usually include at least a processor, memory, and a bus coupling the memory to the processor.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description above. In addition, the present examples are not described with reference to any particular programming language, and various examples may thus be implemented using a variety of programming languages.

Advantageously, embodiments of the invention provide an improve technique for storing files in an online storage system. Since one file can be associated with (or “entangled with”) another file, a user of the online storage system can more easily organize and locate related files. For example, a photographer may capture ten different images of the same scene using a digital camera in a RAW file format. The photographer may then utilize image processing software to stitch together the ten RAW images to generate a final output image. The user may then store the final output image with in the online storage system. Additionally, the user may store each of the ten RAW images in the online storage system, where each of the ten RAW images is associated with the final output image. Accordingly, if the photographer wishes to generate a second output image using the ten RAW images using different parameters of the image processing software, then the photographer can easily access each of the ten RAW files from the online storage system. Since all of the related files are entangled with one another, the photographer can more easily locate the ten “source” RAW files to generate the second output image, when compared to using conventional techniques.

While the forgoing is directed to embodiments of the present invention, other and further embodiments of the invention may be devised without departing from the basic scope thereof. For example, aspects of the present invention may be implemented in hardware or software or in a combination of hardware and software. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present invention, are embodiments of the present invention.

It will be appreciated to those skilled in the art that the preceding examples are exemplary and not limiting. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

I claim:

1. A method for associating images stored a memory associated with an online server, comprising:
receiving a first file having a first file format and a second file having a second file format, wherein the first file is associated with a file size that is smaller than a file size associated with the second file; and
associating the first file with the second file, wherein an image associated with the first file and the second file, when selected by a user, allows the user to access each of the first file and the second file.

2. The method of claim 1, wherein the first file format is one of a JPG file formation, a PNG file format, or a GIF file format.

3. The method of claim 1, further comprising the step of associating a third file with the first file and the second file, wherein when the image is selected by a user allows the user to access the third file.

4. The method of claim 1, wherein the second file format is one of a RAW file format, a CR2 file format, a CRW file format, a NEF file format, a BMP file format, a PSD file format, or a TIFF file format.

5. The method of claim 1, associating the first file with the second file comprises determining that the first file and the second file have the same name.

6. The method of claim 1, further comprising the step of causing the image to be displayed on a display device in a user interface.

7. The method of claim 6, further comprising the step of causing an icon to be display in associated with the image indicating that one or more files are associated with the first file represented by the image.

8. The method of claim 1, further comprising the steps of:
receiving a third file having a third file format;
detecting a capability of converting the third file format to a fourth file format;
converting the third file to a fourth file having the fourth file format; and
associating the third file with the fourth file, wherein a second image associated with the third file and the fourth file, when selected by the user, allows the user to access each of the third file and the fourth file.

9. A computer-readable storage medium storing instructions that, when executed by a processor, cause a computer system to associate images stored in a memory associated with an online server, comprising:
receiving a first file having a first file format and a second file having a second file format, wherein the first file is associated with a file size that is smaller than a file size associated with the second file; and
associating the first file with the second file, wherein an image associated with the first file and the second file, when selected by a user, allows the user to access each of the first file and the second file.

10. The computer-readable storage medium of claim 9, wherein the first file format is one of a JPG file formation, a PNG file format, or a GIF file format.

11. The computer-readable storage medium of claim 9, further comprising the step of associating a third file with the first file and the second file, wherein when the image is selected by a user allows the user to access the third file.

12. The computer-readable storage medium of claim 9, wherein the second file format is one of a RAW file format, a CR2 file format, a CRW file format, a NEF file format, a BMP file format, a PSD file format, or a TIFF file format.

13. The computer-readable storage medium of claim 9, associating the first file with the second file comprises determining that the first file and the second file have the same name.

14. The computer-readable storage medium of claim 9, further comprising the step of causing the image to be displayed on a display device in a user interface.

15. The computer-readable storage medium of claim 14, further comprising the step of causing an icon to be display in associated with the image indicating that one or more files are associated with the first file represented by the image.

16. The computer-readable storage medium of claim 9, further comprising the steps of:
receiving a third file having a third file format;
detecting a capability of converting the third file format to a fourth file format;
converting the third file to a fourth file having the fourth file format; and
associating the third file with the fourth file, wherein a second image associated with the third file and the fourth file, when selected by the user, allows the user to access each of the third file and the fourth file.

17. A computer system for associating images stored a memory associated with an online server, comprising:
a processor; and
a memory storing instructions that, when executed by the processor, cause the computer system to:
receive a first file having a first file format and a second file having a second file format, wherein the first file is associated with a file size that is smaller than a file size associated with the second file, and
associate the first file with the second file, wherein an image associated with the first file and the second file, when selected by a user, allows the user to access each of the first file and the second file.

18. The computer system of claim 17, wherein the first file format is one of a JPG file formation, a PNG file format, or a GIF file format, and the second file format is one of a RAW file format, a CR2 file format, a CRW file format, a NEF file format, a BMP file format, a PSD file format, or a TIFF file format.

19. The computer system of claim 17, associating the first file with the second file comprises determining that the first file and the second file have the same name.

20. The computer system of claim 17, wherein the instructions, when executed by the processor, further cause the computer system to:
receive a third file having a third file format;
detect a capability of converting the third file format to a fourth file format;
convert the third file to a fourth file having the fourth file format; and
associate the third file with the fourth file, wherein a second image associated with the third file and the fourth file, when selected by the user, allows the user to access each of the third file and the fourth file.
